(19) United States
(12) Patent Application Publication
(10) Pub. No.: US 2006/0277905 A1
(43) Pub. Date: Dec. 14, 2006

(54) Hydraulic control device of industrial machinery

(75) Inventor: Masanobu Matsumoto, Kanagawa (JP)

Correspondence Address: BIRCH STEWART KOLASCH & BIRCH, PO BOX 747, FALLS CHURCH, VA, 22040-0747, US

(73) Assignee: BBK BIO Corporation, Tokyo (JP)

(21) Appl. No.: 10/570,490

(22) PCT Filed: Sep. 17, 2004
(86) PCT No.: PCT/JP04/13611

§ 371 Date: Mar. 3, 2006

(30) Foreign Application Priority Data
Sep. 26, 2003 (JP) 2003-335194

(51) Int. Cl. F16D 31/02

(52) U.S. Cl. 60/428

(57) ABSTRACT

A hydraulic control device for an industrial machine, which can efficiently control a high flow rate of a pressure oil by a simple hydraulic instrument configuration, is provided. For this purpose, in a hydraulic control device for a reach stacker, including first and second hydraulic pumps (20, 23) of a variable capacity type driven by an engine (3) of the reach stacker, main hydraulic circuits (21, 24) on two lines connecting these hydraulic pumps to a tilt cylinder (8) and a telescopic cylinder (9) corresponding to the hydraulic pumps, and a raising and lowering control valve (22) and an expansion and contraction control valve (25), interposed in the main hydraulic circuits on the two lines, for controlling the flow rates and directions of pressure oils supplied to the tilt cylinder (8) and the telescopic cylinder (9), a merging block (34), which constitutes a merging circuit for merging the pressure oils of the main hydraulic circuits (21, 24) on the two lines according to operating conditions of the tilt cylinder (8) and the telescopic cylinder (9), is provided on the main hydraulic circuits located upstream of the control valves (22, 25).

### TECHNICAL FIELD

This invention relates to a hydraulic control device for an industrial machine, and relates to a hydraulic control device preferred for use in a heavy duty cargo handling vehicle, such as a reach stacker, which has a plurality of main hydraulically driven working machines.

### BACKGROUND ART

A reach stacker having a spreader suspended from the front end of a telescopic boom has two main hydraulically driven working machines, i.e., a telescopic cylinder for expanding and contracting the telescopic boom, and a tilt cylinder for raising and lowering the telescopic boom. Hydraulic circuits therefor are also composed of two lines, i.e., a line for expansion and contraction, and a line for raising and lowering, and require high flow rates of pressure oil according to the working speed. This has posed the problem that during a vertically ascending operation of the spreader (under unloaded conditions of the reach stacker) or the like, there is need for a fixed pump capable of supplying a high flow rate of pressure oil to each line.

Patent Document 1 discloses, particularly, a technique of providing a merging valve for merging pressure oils from two hydraulic pumps in a hydraulic drive device for a working machine, such as a hydraulic shovel.

That is, as shown in FIG. 4, there are provided an engine 100; a first hydraulic pump 101 and a second hydraulic pump 102, each of a variable capacity type, driven by the engine 100; a group of first directional control valves 103 of a center bypass type connected to the first hydraulic pump 101; a group of second directional control valves of a center bypass type connected to the second hydraulic pump 102 and including a merging directional control valve 104; a merging valve 106, connected to the farthest downstream directional control valve of the group of first directional control valves 103 via a center bypass passage 105, for merging the pressure oil of the first hydraulic pump 101 with the pressure oil of the second hydraulic pump 102 to enable the merged pressure oil to be supplied to the merging directional control valve 104 of the group of second directional control valves; a merging circuit 107 for bringing the merging valve 106 and a supply port of the merging directional control valve 104 into communication; and a merging actuator 108 controlled by the merging directional control valve 104.

According to the above-described configuration, when the merging actuator 108 is to be driven, the merging directional control valve 104 is switched to a right-hand position in FIG. 4 by a pilot pressure, and the merging valve 106 is switched to a closed position against a spring force. As a result, a hydraulic circuit between the center bypass passage 105 and the tank side is shut off. Thus, the pressure oil of the first hydraulic pump 101 is supplied to the supply port of the merging directional control valve 104 via the center bypass passage 105 and the merging circuit 107 upon merger with the pressure oil of the second hydraulic pump 102. The pressure oil, as the product of merger between the pressure oils from the first hydraulic pump 101 and the second hydraulic pump 102, is supplied from the merging directional control valve 104 to the merging actuator 108. The merging actuator 108 is thus activated to drive a crusher (as an attachment) of a hydraulic shovel (not shown), performing crushing work, etc. for rocks.

Patent Document 1: Japanese Patent Application Laid-Open No. 2001-295803 (FIG. 5)

### DISCLOSURE OF THE INVENTION

Problems to be Solved by the Invention:

With the hydraulic drive device of Patent Document 1, however, when, for a combined operation of the crusher and an arm and a boom (not shown), the concerned directional control valve included in the group of first directional control valves 103 is also switched, for example, the pressure oil of the first hydraulic pump 101 is supplied to the concerned directional control valve 103, and the center bypass passage 105 is shut off by the concerned directional control valve 103 on the hydraulic circuit. Thus, the pressure oil of the first hydraulic pump 101 is not supplied to the merging circuit 107. In other words, it is not that the pressure oil of the first hydraulic pump 101 is merged with the pressure oil of the second hydraulic pump 102 and supplied to the merging actuator 108.

In the case of the above-described combined operation, Patent Document 1 discloses as follows: In the actual operation, there are few cases where the concerned directional control valve 103 completely closes the center bypass passage 105. Thus, a part of the pressure oil of the first hydraulic pump 101 tends to be supplied to the merging circuit 107. As a result, the merging actuator 108 is prone to be driven by the part of the pressure oil of the first hydraulic pump 101 and the pressure oil of the second hydraulic pump 102.

With the above-mentioned combined operation, however, the center bypass passage 105 for the concerned directional control valve 103 is necessarily constricted, so that the flow rate of the pressure oil supplied from the first hydraulic pump 101 is itself limited. This has resulted in the drawback that a requirement of the merging actuator 108 for a high flow rate of the pressure oil (in other words, a high speed action) cannot be fully satisfied.

It is therefore an object of the present invention to provide a hydraulic control device for an industrial machine, the hydraulic control device being capable of efficiently controlling a high flow rate of a pressure oil by a simple configuration of a hydraulic instrument.

Means for Solving the Problems:

A hydraulic control device for an industrial machine according to the present invention, intended for attaining the above object, is a hydraulic control device for an industrial machine, including

a plurality of variable capacity hydraulic pumps driven by a power plant,

main hydraulic circuits on a plurality of lines connecting the hydraulic pumps to a plurality of hydraulically driven working machines, and

control valves, interposed in the main hydraulic circuits on the plurality of lines, for controlling flow rates and directions of pressure oils supplied to the hydraulically driven working machines, and characterized in that

a merging block, which constitutes a merging circuit for merging the pressure oils of the main hydraulic circuits on the plurality of lines according to operating conditions of the hydraulically driven working machines, is provided on the main hydraulic circuits located upstream of the control valves.

Preferably, differential circuit blocks, which reflux the pressure oils from discharge (rod-side) ports of the hydraulically driven working machines to supply (head-side) ports of the hydraulically driven working machines, are provided on the main hydraulic (cylinder drive) circuits between the control valves and the hydraulically driven working machines corresponding to the control valves, thereby refluxing the pressure oils during the merging of the pressure oils.

Preferably, control over swash plate inclination angles of the hydraulic pumps is load-responsive, and the hydraulic pumps and the control valves corresponding to the hydraulic pumps are connected together by load pressure (load sensing pressure) circuits.

It is preferred because of system efficiency that the hydraulically driven working machines are a tilt cylinder and a telescopic cylinder for a telescopic boom of a reach stacker, and the pressure oils of the main hydraulic circuits on the plurality of lines, and load pressures of load pressure circuits are simultaneously merged by the merging block during a combined operation of both cylinders.

Effects of the Invention:

According to the present invention with the above features, during a combined operation or the like of the hydraulically driven working machine under unloaded conditions at a lower load pressure than that under loaded conditions of the machine, the pressure oils of the main hydraulic circuits on the plurality of lines are merged, and the plurality of hydraulic pumps are used as if they were a single pump. By so doing, a high flow rate of pressure oil can be controlled efficiently to achieve a no-load high speed action. Furthermore, the present invention merely involves a configuration in which the merging block is provided in the main hydraulic circuits located upstream of the control valves. Hence, the desired function can be performed with the use of a simple hydraulic instrument configuration.

### BRIEF DESCRIPTION OF THE DRAWINGS

FIG. 1 A hydraulic circuit diagram of a reach stacker showing an embodiment of a hydraulic control device for an industrial machine.

FIGS. 2(a) to 2(c) Hydraulic circuit diagrams showing different operating states.

FIG. 3 A side view of the reach stacker.

FIG. 4 A hydraulic circuit diagram showing a conventional example.

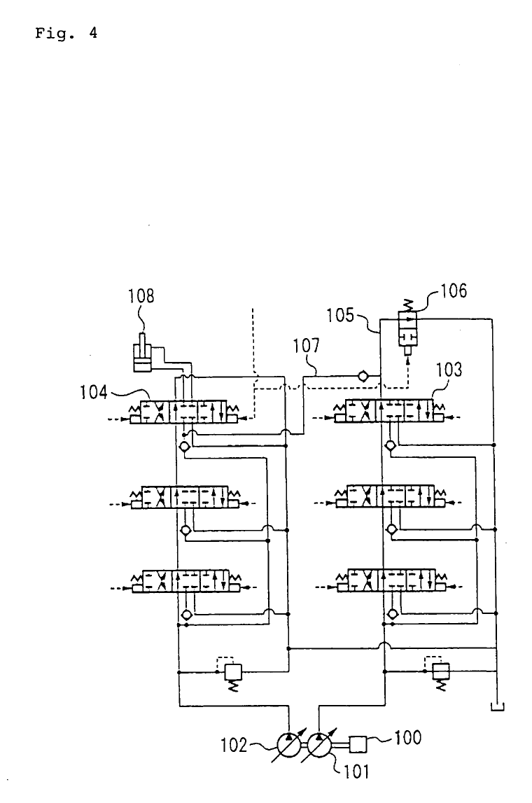

### DESCRIPTION OF THE REFERENCE NUMERALS

1 front wheel, 2 rear wheel, 3 engine, 4 frame, 5 tower, 6 telescopic boom, 7 spreader, 8 tilt cylinder, 9 telescopic cylinder, 10 rail, 11 cab, 20 first hydraulic pump, 21 main hydraulic circuit, 22 raising and lowering control valve, 23 second hydraulic pump, 24 main hydraulic circuit, 25 expansion and contraction control valve, 26a, 26b servo valves, 27a, 27b pressure compensating valves, 28a, 28b pressure control valves, 29 tank, 30, 31 load pressure circuits, 32, 33 check valves, 34 merging block, 35, 36 merger/independence electromagnetic selector valves, 37, 38 differential circuit blocks, 39a, 39b electromagnetic selector valves, 40a, 40b electromagnetic selector valves.

### BEST MODE FOR CARRYING OUT THE INVENTION

A hydraulic control device for an industrial machine according to the present invention will now be described in detail by an embodiment with reference to the accompanying drawings.

### EMBODIMENT

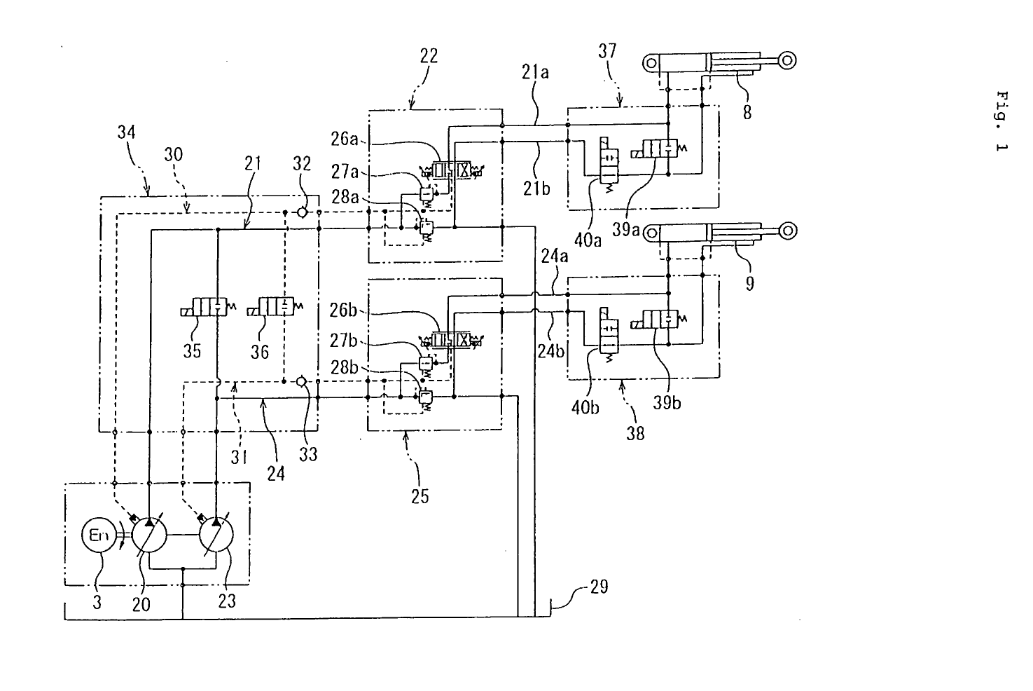

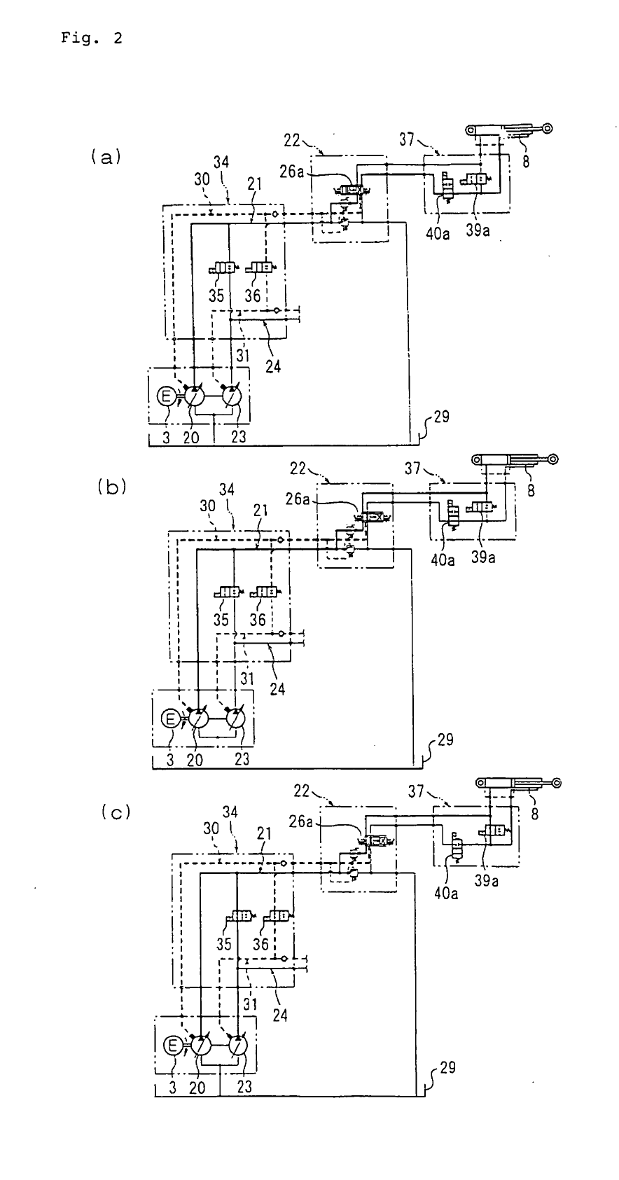

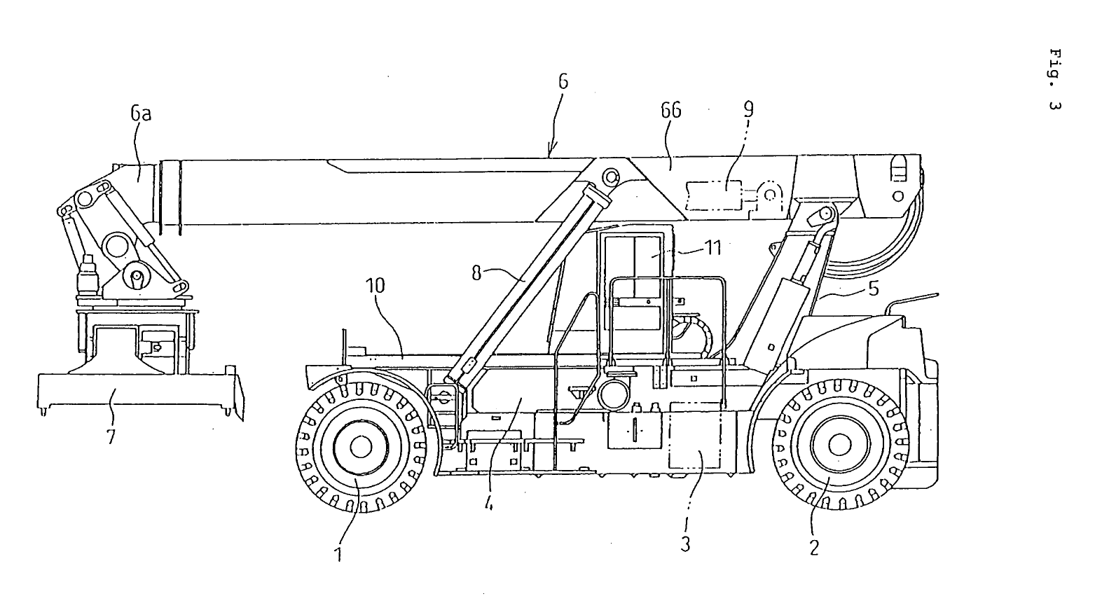

FIG. 1 is a hydraulic circuit diagram of a reach stacker showing an embodiment of a hydraulic control device for an industrial machine. FIGS. 2(a) to 2(c) are hydraulic circuit diagrams showing different operating states. FIG. 3 is a side view of the reach stacker.

As shown in FIG. 3, a reach stacker comprises a telescopic boom 6 supported on a frame 4 via a tower 5 so as to be raisable and lowerable, the frame 4 having a pair of front wheels 1 and rear wheels 2 and being cable of running by the action of an engine (power plant) 3. A spreader 7, which can hold a long container or the like, is suspended from the front end of an inner boom 6a of the telescopic boom 6.

The telescopic boom 6 makes rising and lowering motions by the action of two tilt cylinders (hydraulically driven working machines) 8 provided as a pair between the frame 4 and an outer boom 6b, and also makes expanding and contracting motions by the action of a single telescopic cylinder (hydraulically driven working machine) 9 provided between the inner boom 6a and the outer boom 6b. A cab 11 is provided on the frame 4 so as to be slidable in a longitudinal direction via a pair of (i.e., right and left) rails 10.

As shown in FIG. 1, the two tilt cylinders 8 (only one of them is shown for convenience's sake in the drawing) are connected, via a main hydraulic (cylinder drive) circuit 21, to a first hydraulic pump 20 of a variable capacity type driven by the engine 3. These tilt cylinders 8 make expanding and contracting motions when a pressure oil from the first hydraulic pump 20 is supplied and discharged by a raising and lowering control valve (device) 22 interposed in the main hydraulic circuit 21. The single telescopic cylinder 9 is connected, via a main hydraulic (cylinder drive) circuit 24, to a second hydraulic pump 23 of a variable capacity type similarly driven by the engine 3. The single telescopic cylinder 9 makes expanding and contracting motions when a pressure oil from the second hydraulic pump 23 is supplied and discharged by an expansion and contraction control valve (device) 25 interposed in the main hydraulic circuit 24.

The raising and lowering control valve (device) 22 includes a servo valve 26a for controlling the flow rate and direction of the pressure oil supplied to the tilt cylinder 8, a pressure compensating valve 27a, provided in a passage ahead of the servo valve 26a, for maintaining a constant flow rate under varying pressure (load), and a pressure control valve 28a provided in a passage leading to a tank 29. The expansion and contraction control valve (device) 25 includes a servo valve 26b for controlling the flow rate and direction of the pressure oil supplied to the telescopic cylinder 9, a pressure compensating valve 27b, provided in a passage ahead of the servo valve 26b, for maintaining a constant flow rate under varying pressure (load), and a pressure control valve 28b provided in a passage leading to the tank 29.

Control over the swash plate inclination angles of the first hydraulic pump 20 and the second hydraulic pump 23 is load-responsive. The hydraulic pumps 20, 23 and the servo valves 26a, 26b corresponding to the hydraulic pumps 20, 23, respectively, are connected together by load pressure circuits 30, 31. In FIG. 1, the reference numerals 32, 33 denote check valves.

In the main hydraulic circuits 21, 24 and the load pressure circuits 30, 31 located upstream of the control valves 22, 25, there is provided a merging block 34 constituting a merging circuit which merges the pressure oils of the main hydraulic circuits 21, 24 on the two lines, and the load pressures of the load pressure circuits 30, 31 on the two lines, according to the operating conditions of the tilt cylinders 8 and the telescopic cylinder 9. That is, a merger/independence electromagnetic selector valve 35 is provided on a passage connecting the main hydraulic circuits 21, 24 on the two lines, while a merger/independence electromagnetic selector valve 36 is provided on a passage connecting the load pressure circuits 30, 31 on the two lines.

On the main hydraulic circuits 21, 24 between the control valves 22, 25 and the tilt cylinder 8 and the telescopic cylinder 9, differential circuit blocks 37, 38 are provided for refluxing the pressure oils from discharge (rod-side) ports during expansion of the tilt cylinder 8 and the telescopic cylinder 9 to supply (head-side) ports during expansion of these cylinders. That is, electromagnetic selector valves 39a, 39b, which can be opened during a predetermined expansion, are provided on bypass passages connecting head-side passages 21a, 24a and rod-side passages 21b, 24b of the main hydraulic circuits 21, 24. Moreover, electromagnetic selector valves 40a, 40b, which can be closed during a predetermined expansion, are provided on the rod-side passages 21b, 24b on the side of the control valves 22, 25 relative to the branch points of the bypass passages.

The servo valves 26a, 26, the merger/independence electromagnetic selector valves 35, 36, and the electromagnetic selector valves 39a, 39b, 40a, 40b are driven and controlled by a working machine controller (ECU) (not shown).

The working machine controller receives inlet signals from a joystick (not shown) operated by an operator inside the cab 11, and oil pressure sensors (not shown) incorporated in the tilt cylinder 8 and the telescopic cylinder 9. In response to the inlet signals, the working machine controller controls the merging block 34 so as to simultaneously merge the pressure oils of the main hydraulic circuits 21, 24 on the two lines, and the load pressures of the load pressure circuits 30, 31 on the two lines, for example, during a combined operation of the tilt cylinder 8 and the telescopic cylinder 9 under unloaded conditions of the reach stacker (when the spreader 7 does not hold a long container or the like), and controls the differential circuit 37 or 38 so as to reflux the pressure oil on the rod side to the head side during the expansion of the tilt cylinder 8 or the telescopic cylinder 9 which requires a high flow rate of pressure oil, thereby making it possible to achieve a no-load high speed action of the reach stacker.

On the other hand, the working machine controller controls the merging block 34 so as to keep the pressure oils of the main hydraulic circuits 21, 24 and the load pressures of the load pressure circuits 30, 31 as individual two lines, without merging these pressure oils and these load pressures, during a combined operation of the tilt cylinder 8 and the telescopic cylinder 9 under loaded conditions of the reach stacker (when the spreader 7 holds a long container or the like), thereby making it possible to achieve a load-responsive action of the reach stacker under loaded conditions.

A concrete description will be offered based on FIGS. 2(a) to 2(c). During contraction (individual operation) of the tilt cylinder 8 regardless of the loaded condition of the reach stacker, as shown in FIG. 2(a), the servo valve 26a of the raising and lowering control valve 22 is switched to the right-hand position in the drawing, and the merger/independence electromagnetic selector valves 35, 36 of the merging block 34 are both closed. In the differential circuit block 37, the electromagnetic selector valve 39a is closed, while the electromagnetic selector valve 40a is opened.

As a result, the pressure oil of the first hydraulic pump 20 passes through the main hydraulic circuit 21, and supplied at a predetermined flow rate to the rod side of the tilt cylinder 8 by the servo valve 26a, without being merged with the pressure oil of the second hydraulic pump 23. On this occasion, the first hydraulic pump 20 varies in the amount of discharge in response to the load pressure of the load pressure circuit 30, exercising efficient control. The differential circuit block 37 does not function.

During expansion (individual operation) of the tilt cylinder 8 under the loaded conditions of the reach stacker, as shown in FIG. 2(b), the servo valve 26a of the raising and lowering control valve 22 is switched to the left-hand position in the drawing, and the merger/independence electromagnetic selector valves 35, 36 of the merging block 34 are both closed. In the differential circuit block 37, the electromagnetic selector valve 39a is closed, while the electromagnetic selector valve 40a is opened.

As a result, the pressure oil of the first hydraulic pump 20 passes through the main hydraulic circuit 21, and supplied at a predetermined flow rate to the head side of the tilt cylinder 8 by the servo valve 26a, without being merged with the pressure oil of the second hydraulic pump 23. On this occasion, the first hydraulic pump 20 varies in the amount of discharge in response to the load pressure of the load pressure circuit 30, exercising efficient control. The differential circuit block 37 does not function.

Next, during expansion of the tilt cylinder 8 under unloaded conditions at a lower load pressure than that under loaded conditions of the reach stacker (i.e., during a combined operation of the tilt cylinder 8 in combination with the telescopic cylinder 9 when the telescopic boom 6 vertically ascends), as shown in FIG. 2(c), the servo valve 26a of the raising and lowering control valve 22 is switched to the left-hand position in the drawing, and the merger/independence electromagnetic selector valves 35, 36 of the merging block 34 are both opened. In the differential circuit block 37, the electromagnetic selector valve 39a is opened, while the electromagnetic selector valve 40a is closed.

As a result, the pressure oil of the second hydraulic pump 23 is merged with the pressure oil of the first hydraulic pump 20 via the merger/independence electromagnetic selector valve 35, and a required high flow rate of pressure oil is supplied to the head side of the tilt cylinder 8 by the servo valve 26a. That is, at the initial stage of vertical ascent of the telescopic boom 6, the load is higher on the tilt cylinder 8 than on the telescopic cylinder 9, thus requiring a high flow rate of pressure oil. The adequate flow rate for this requirement can be supplied by causing the first hydraulic pump 20 and the second hydraulic pump 23 to function as if they were a single pump.

During the above action, the differential block 37 also functions to reflux the pressure oil on the rod side of the tilt cylinder 8 to the head side of the tilt cylinder 8 via the electromagnetic selector valve 39a without returning it to the tank 29. Thus, the flow rate of the pressure oil supplied to the head side of the tilt cylinder 8 is increased, thereby achieving an even higher speed action. On this occasion, the same load pressure is exerted on the first hydraulic pump 20 and the second hydraulic pump 23 via the merger/independence electromagnetic selector valve 36, and the amount of discharge become variable according to this load pressure. Thus, efficient control is effected.

Explanations for the actions for the telescopic cylinder 9 are omitted, because it is self-evident that the same actions as those for the tilt cylinder 8 are performed for the telescopic cylinder 9. In the above-described embodiment, the differential circuit blocks 37, 38 may be omitted, and the first and second hydraulic pumps 20 and 23 need not be rendered directly responsive to the load pressure by the load pressure circuits 30, 31.

### INDUSTRIAL APPLICABILITY

The hydraulic control device for an industrial machine according to the present invention can be applied not only to a heavy duty cargo-handling vehicle such as a reach stacker, but also to an industrial (transport) machine such as a crane.

1. A hydraulic control device for an industrial machine, including
a plurality of variable capacity hydraulic pumps driven by a power plant,
main hydraulic circuits on a plurality of lines connecting said hydraulic pumps to a plurality of hydraulically driven working machines, and
control valves, interposed in said main hydraulic circuits on the plurality of lines, for controlling flow rates and directions of pressure oils supplied to said hydraulically driven working machines, and characterized in that
a merging block, which constitutes a merging circuit for merging the pressure oils of said main hydraulic circuits on the plurality of lines according to operating conditions of said hydraulically driven working machines, is provided on said main hydraulic circuits located upstream of said control valves.

2. The hydraulic control device for an industrial machine according to claim 1, characterized in that differential circuit blocks, which reflux the pressure oils from discharge ports of said hydraulically driven working machines to supply ports of said hydraulically driven working machines, are provided on said main hydraulic circuits between said control valves and said hydraulically driven working machines corresponding to said control valves, thereby refluxing said pressure oils during said merging of the pressure oils.

3. The hydraulic control device for an industrial machine according to claim 1, characterized in that control over swash plate inclination angles of said hydraulic pumps is load-responsive, and said hydraulic pumps and said control valves corresponding to said hydraulic pumps are connected together by load pressure circuits.

4. The hydraulic control device for an industrial machine according to claim 1, characterized in that said hydraulically driven working machines are a tilt cylinder and a telescopic cylinder for a telescopic boom of a reach stacker, and the pressure oils of said main hydraulic circuits on the plurality of lines, and load pressures of load pressure circuits are simultaneously merged by said merging block during a combined operation of said cylinders.

5. The hydraulic control device for an industrial machine according to claim 2, characterized in that control over swash plate inclination angles of said hydraulic pumps is load-responsive, and said hydraulic pumps and said control valves corresponding to said hydraulic pumps are connected together by load pressure circuits.

6. The hydraulic control device for an industrial machine according to claim 2, characterized in that said hydraulically driven working machines are a tilt cylinder and a telescopic cylinder for a telescopic boom of a reach stacker, and the pressure oils of said main hydraulic circuits on the plurality of lines, and load pressures of load pressure circuits are simultaneously merged by said merging block during a combined operation of said cylinders.

7. The hydraulic control device for an industrial machine according to claim 3, characterized in that said hydraulically driven working machines are a tilt cylinder and a telescopic cylinder for a telescopic boom of a reach stacker, and the pressure oils of said main hydraulic circuits on the plurality of lines, and load pressures of load pressure circuits are simultaneously merged by said merging block during a combined operation of said cylinders.
